(19) United States
(12) Patent Application Publication
(10) Pub. No.: US 2013/0239474 A1
(43) Pub. Date: Sep. 19, 2013

(54) METHOD FOR CHANGING COLOR OF ORCHIDS

(71) Applicant: JUI-TE CHUANG, Tainan City (TW)

(72) Inventor: JUI-TE CHUANG, Tainan City (TW)

(21) Appl. No.: 13/423,540

(22) Filed: Mar. 19, 2012

(51) Int. Cl. A01G 7/00

(52) U.S. Cl. 47/57.5

(57) ABSTRACT

A method for changing color of orchids comprises the steps of: first, forming a housing space in a stalk of a plant; and second, providing a solid dye smaller than the diameter of the stalk and dispensing the solid dye via a suction means into the housing space. Water is supplied to the plant before or after the solid dye is dispensed to dissolve the solid dye to facilitate absorption. Thus the color of the petals of the plant can be changed quickly and evenly. Diversified and brilliant colors can be formed on the petals through the simple dyeing process.

### FIELD OF THE INVENTION

The present invention relates to a method for changing flower color and particularly to an improved method for changing color of orchids.

### BACKGROUND OF THE INVENTION

Taiwan is situated in the subtropical zone with abundant sunshine and high humidity, thus is a desired environment to grow various types of orchids. At present the cultivating area for orchids is about 461 hectares, approximated 4% of total flower growing area. But the value of orchids is about 24.4 hundred millions NT dollars, approximated 22.6% of total flower product values. Every year total export number of orchid plants is about 40 millions. As a result, orchids growing business is very profitable, and Taiwan has earned a reputation of “Orchid kingdom”.

Orchid is widely loved by many people for a long history, and also has earned a nickname of “King's fragrance”. It has been a preferable gift for many people, and can be seen in many households or offices to enrich the graceful atmosphere of the ambience. However, in the past, the orchids are mostly in white color or monochromatic, and give people the impression of dull, lack variety and unique features, hence consumer's repetitive buying desire is lower. With gradual increasing of life quality, people nowadays also have a higher level of aesthetic requirements. The monochromatic orchid with limited color selections is no longer as attractive as it once was in the mind of many consumers, and purchase motivation also gradually decreases.

To address the aforesaid concerns, some breeders have cultivated new non-indigenous orchids by exploiting their epiphytism to have more than two types of colors on each of them. But such a technique requires a prolonged period of cultivation and research. Moreover, growing of the orchid needs many types of nutrition elements. A small lapse could cause deficiency of nutrition supply and make the orchid wilted before it's fully grown. Hence growing control of the orchid is difficult, and there is still room for improvement in terms of breeding efficiency.

### SUMMARY OF THE INVENTION

In view of the aforesaid problems in the conventional techniques, the present invention aims to provide a method for changing color of orchids to increase efficiency of a dyeing process and decrease difficulty thereof.

The primary object of the invention is to solve the shortcomings related to color changing of the orchids and improve dyeing efficiency and reduce process difficulty.

To achieve the foregoing object, the method of the invention comprises the steps as follows: first, forming a housing space in a stalk of an orchid plant; and second, providing a solid dye smaller than the diameter of the stalk and dispensing the solid dye via a suction means into the housing space. Water is supplied to the plant before or after the solid dye is dispensed to dissolve the solid dye to facilitate even absorption. Through the vascular bundle of the plant, the dissolved dye is transported to the petals of the orchid so that the orchid can absorb the dissolved dye automatically and quickly.

By means of the aforesaid technique, compared with the conventional technique, the invention provides many benefits, notably: through dispensing the fine solid dye into the orchid, the orchid can absorb the dye automatically and quickly to be dyed evenly without involving gene modification. Hence operation efficiency of changing the flower color can be improved and difficulty of cultivation can be reduced to achieve a wide variety of dyeing effects for the orchids. Thus diversified and novel orchids can be cultivated, and value and marketability thereof also can be enhanced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a process flowchart of the invention.

FIG. 2 is a schematic view of an embodiment of the invention.

### DETAILED DESCRIPTION OF THE PREFERRED EMBODIMENT

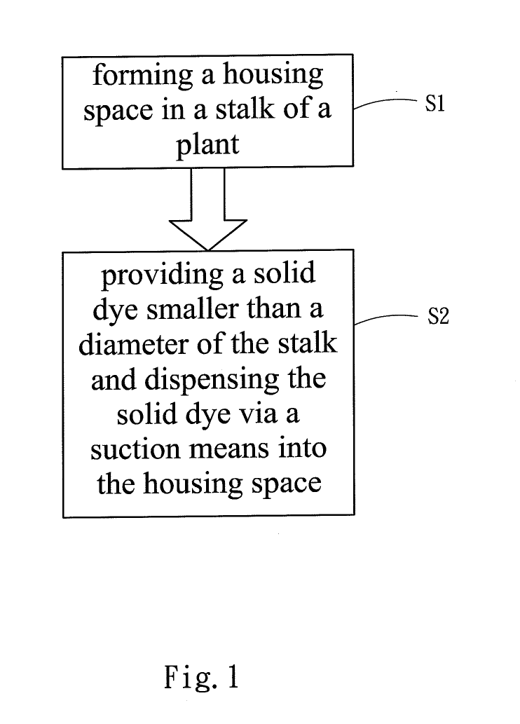

Please refer to FIG. 1, the present invention aims to provide a method for changing color of orchids that comprises the steps as follows:

Step S1: forming a housing space in a stalk of a plant; and

Step S2: providing a solid dye smaller than the diameter of the stalk and dispensing the solid dye via a suction means into the housing space.

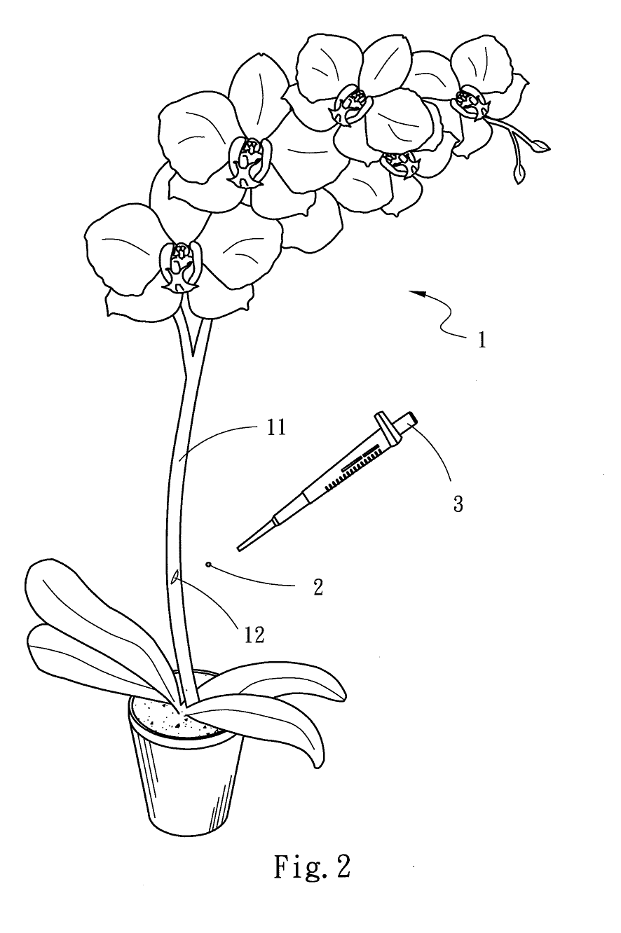

Please refer to FIG. 2 for an embodiment of the invention. First, forming a housing space 12 in a stalk 11 of an orchid plant 1 as desired; next, providing a solid dye 2 smaller than the diameter of the stalk 11 that can be in a form of powder or grain, and dispensing the solid dye 2 via a suction means 3 that can be a small suction tube into the housing space 12. The amount of the solid dye 2 being dispensed is ranged from 0.001 g to 0.1 g. Moreover, water is supplied to the plant 1 before or after the solid dye 2 is dispensed to dissolve the solid dye 2 to facilitate even absorption. Through the vascular bundle of the plant 1, the dissolved dye 2 is transported to the petals of the orchid to be absorbed automatically and quickly to achieve notable dyeing effect without forming the housing space 12 on the root of the stalk 11. Hence colorful orchids can be directly cultivated without involving gene modification, and operation efficiency of flower color can be greatly improved. The difficulty of cultivation can be reduced to generate a wide variety of dyeing effect to breed diversified and novel orchids.

As a conclusion, the method according to the invention provides significant improvements over the conventional technique of changing color for the orchids. The dyeing technique provided by the invention can also be implemented easily.

While the preferred embodiment of the invention has been set forth for the purpose of disclosure, it is not the limitation of the invention, modifications of the disclosed embodiment of the invention as well as other embodiments thereof may occur to those skilled in the art. Accordingly, the appended claims are intended to cover all embodiments which do not depart from the spirit and scope of the invention.

1. A method for changing color of orchids, comprising steps of:
step S1: forming a housing space in a stalk of a plant; and
step S2: providing a solid dye smaller than a diameter of the stalk and dispensing the solid dye via a suction means into the housing space;
wherein the plant is supplied with water before and after the solid dye is dispensed to dissolve the solid dye and allow the plant to absorb the solid dye evenly.

2. The method of claim 1, wherein the solid dye is in a form of powder.

3. The method of claim 1, wherein the solid dye is in a form of grain.

4. The method of claim 1, wherein the solid dye is dispensed at a dose weighted between 0.001 g and 0.1 g.

5. The method of claim 2, wherein the solid dye is dispensed at a dose weighted between 0.001 g and 0.1 g.

6. The method of claim 3, wherein the solid dye is dispensed at a dose weighted between 0.001 g and 0.1 g.

7. (canceled)

8. The method of claim 1, wherein the suction means is a small suction tube.
